(19) United States
(12) Patent Application Publication
(10) Pub. No.: US 2004/0186966 A1
(43) Pub. Date: Sep. 23, 2004

(54) System chip and related method of data access

(75) Inventors: Chih-Yung Chen, Hsin-Tien City (TW); Kun-Long Lin, Hsin-Tien City (TW)

Correspondence Address: LOWE HAUPTMAN GILMAN & BERNER, LLP, Suite 310, 1700 Diagonal Road, Alexandria, VA, 22314, US

(73) Assignee: VIA TECHNOLOGIES, INC.

(21) Appl. No.: 10/765,897

(22) Filed: Jan. 29, 2004

(30) Foreign Application Priority Data
Jan. 30, 2003 (TW) 092102128

(51) Int. Cl. G06F 12/00

(52) U.S. Cl. 711/154

(57) ABSTRACT

A system chip and the related method of data access are provided. The system chip encompasses a central processing unit and a control circuit of interface. The control circuit of interface is configured for transforming an internal access address of data into one corresponded to an external temporary segment of data, so that the CPU may directly access data with the external temporary segment of data. The method of data access includes the steps of determining whether an access address of data is correspondent to an internal memory, transforming the access address into one correspondent to an external memory, and requesting data access with the external memory. The data access may be suspended prior to sending the CPU a confirmation of request while the data access may be executed with the external memory when the request is confirmed by the external memory.

### BACKGROUND OF THE INVENTION

This invention relates to a control chip and related method of data access, and more particularly to a system chip and related methods of data access that does not require to including an embedded memory used for storing parameters associated program flow controls and information regarding temporary arithmetic operations.

### BACKGROUND OF THE INVENTION

Microprocessors broadly apply various electric/control fields. Generally, a typical microprocessor includes internal registers for storing temporary data necessary for the parameters of flow control or numerical arithmetic. The more complex the controlled system is, the more the internal register is. However, nowadays microprocessors generally need an external memory as aids for the internal registers with insufficient capacity.

FIG. 1A is a schematic diagram illustrating an ASIC 100 (Application Specific Integrated Circuit) in accordance with the prior art. A central processing unit 104A includes a 256-byte internal register 104B. For the improved complexity of a controlled system, the conventional ASIC 100 generally builds a SRAM 106(Static Random Access Memory) configured for providing the central processing unit 104A with more storage spaces, such as 4K-byte SRAM. Furthermore, the ASIC 100 still includes an internal circuit 102 configured for electric connection.

FIG. 1B is a timing diagram of clock illustrating the timing operation during the access circle of the central processing unit 104A with the SRAM 106 in accordance with the prior art. The exemplary central processing unit 104A accomplishing with a series of 4 read/write circles signal (RD/WR) is illustrated in conjunction with the reading or writing of the data in the temporary storage 202. The central processing unit 104A could access data at any time from the SRAM 106 without delay due to the SRAM 106 is used only for the central processing unit 104A. Shown in FIG. 1B, the central processing unit 104A accomplishes data reading or writing of the SRAM 106 with a series of 4 clock circles of processor 112, on condition that accomplishing the address latch enable signal 110 (ALE). However, it is necessary to have a large capacity SRAM 106 for applying the ASIC 100 to a gigantic or complex system, as a result, ASIC 100 would occupy more area and with more complex manufacturing and higher cost.

### SUMMARY OF THE INVENTION

The methods and systems of the present invention address many of the shortcomings of the prior art. The present invention provides a system chip to improve the design of temporary storage. The present invention also provides a system chip with reducing temporary memory, and further provides a system chip with the reducing area and manufacture cost.

The present invention also provides a system chip with capable of accessing data from an external temporary data segment of an external memory chip.

A system chip and a related method of data access are provided. The system chip encompasses a central processing unit, an external temporary data segment, coupled to the control chip with a memory bus, and a memory interface control circuit for transforming an internal data accessing address and corresponding to the external temporary data segment, so that the CPU could directly access data from the external temporary data segment. The method of data access includes the steps of determining whether a data accessing address belongs to an internal memory; transforming the data accessing address and corresponding to the external temporary data segment; sending a data access request to the external temporary data segment; and suspending data access of the control chip until a confirmed data access request is replied, then recovering data access from the external temporary data segment.

### BRIEF DESCRIPTION OF DRAWINGS

The foregoing and other objects, features, and advantages of the invention will become more readily apparent upon reference to the following detailed description of a presently preferred embodiment, when taken in conjunction with the accompanying drawings in which like numbers refer to like parts, and in which:

FIG. 1A is a schematic diagram illustrating an ASIC in accordance with the prior art;

FIG. 1B is a timing diagram of clock illustrating the timing operation during the access cycle of a central processing unit from a SRAM in accordance with the prior art;

FIG. 2A is a schematic diagram illustrating a preferred embodiment in accordance with the present invention;

FIG. 2B is a schematic diagram illustrating a preferred embodiment in accordance with the present invention;

FIG. 3 is a clock timing diagram illustrating the timing operation during the access cycle of the central processing unit 201A from the temporary data segment 210 in FIG. 2B; and

FIG. 4 is a flowchart diagram illustrating the steps of data access for the central processing unit 201A from the temporary data segment 210 of the memory chip 21 in accordance with the present invention.

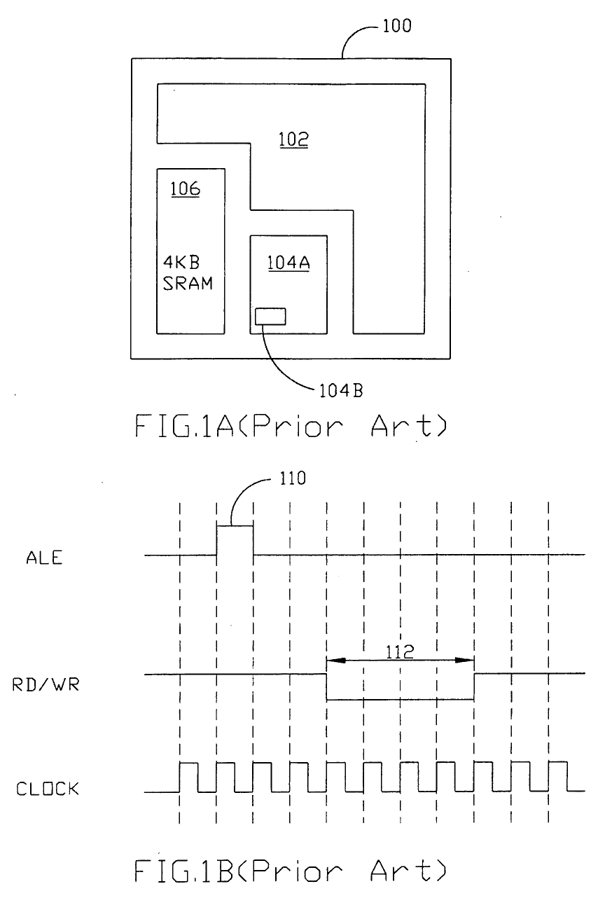

### DETAILED DESCRIPTION OF THE INVENTION

An appropriate and preferred embodiment will now be described in the form of a CD drive that performs reading or writing data. It should be noted, however, that this embodiment is merely an example and can be variously modified without departing from the scope of the present invention.

A system chip and a related method of data access are provided. The system chip encompasses a central processing unit, an external temporary data segment, coupled to the control chip with a memory bus, and a memory interface control circuit for transforming an internal data accessing address and corresponding to the external temporary data segment, so that the CPU could directly access data from the external temporary data segment. The method of data access includes the steps of determining whether a data accessing address belongs to an internal memory; transforming the data accessing address and corresponding to the external temporary data segment; sending a data access request to the external temporary data segment; and suspending data access of the control chip until a confirmed data access request is replied, then recovering data access from the external temporary data segment.

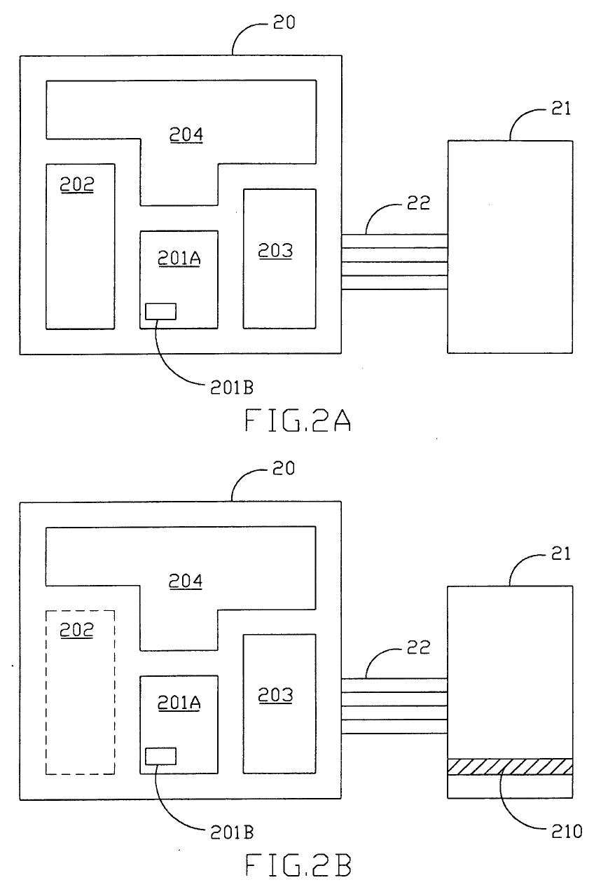

FIGS. 2A-2B show schematic diagrams illustrating a preferred embodiment in accordance with the present invention. Shown in FIG. 2A-2B, an exemplary control chip 20 is embodied in a compact disc (CD) drive. The control chip 20 includes a central processing unit 201A (or a microprocessor) with a 256-byte internal register 201B, and a 4 K-byte temporary storage 202. In an embodiment, the temporary storage 202 is a static random access memory (SRAM) providing the extra temporary space of accessing data for the central processing unit 201A to use. Furthermore, the control chip 20 also includes other necessary circuit 204. However, for any CD drive, in addition to the control chip 20, a memory chip 21 is necessary for temporarily storing a large amount of data. In any CD drive, the memory chip 21 with a large capacity for temporarily storing reading data from compact disk is necessary for the control chip 20. Thus, in a preferred embodiment, the memory chip 21 includes an 8 M-byte dynamic random access memory (DRAM). It is noted that any suitable data-storing apparatus in other embodiments can be used without departing from the scope of the present invention. The data in the memory chip 21 differs from those in both internal register 201B and temporary storage 202. Generally, the data, in either internal register 201B or temporary storage 202, includes multitudes of control flags (stored in the internal register 201B), flow control parameters and numerical arithmetic necessary (stored in the temporary storage 202) for the central processing unit 201A operating, while the memory chip 21 is provided for the whole CD drive to store data. Shown in FIG. 2A, the control chip 20 couples with the memory chip 21 through a memory bus 22. On the other hand, a memory interface control circuit 203 in the control chip 20 is configured for processing the access operation of the central processing unit 201A or necessary circuit 204. That is, either the central processing unit 201A or necessary circuit 204 sends data addresses to the memory interface control circuit 203 and then acquires the data stored in the memory chip 21 through the memory interface control circuit 203, on condition that the central processing unit 201A or necessary circuit 204 needs to access the data stored in the memory chip 21.

Accordingly, in the present invention, the memory chip 21, 8 M-byte DRAM for example, is designed to divide a portion for a temporary data segment 210 with the capacity equal to one of the temporary storage 202 shown in FIG. 2B. Therefore, the temporary data segment 210 in the memory chip 21 could be regarded as the temporary storage 202. The design of the temporary data segment 210, used for storing the flow control parameters and numerical arithmetic necessary for the central processing unit 201A operating, without reducing the performance of the whole memory chip 21, for that reason of the exemplary designed 4 K-byte temporary data segment 210 is much smaller with comparing to the exemplary total 8 M-byte DRAM memory chip 21. Furthermore, the control chip 20 could reduce area occupied, manufacture cost of the temporary storage 202 with having the temporary data segment 210.

In the present invention, the temporary data segment 210 could be regarded as the temporary storage 202 originally in the control chip 20, that is, notwithstanding the central processing unit 201A looks like to access data from the temporary storage 202, but in fact, it accesses data from the temporary data segment 210. Thus, the total efficiency of the control chip 20 can perform without influences.

However, unlike the temporary storage 202 in the control chip 20 is only provided for the central processing unit 201A, the memory chip 21 is provided for the whole CD drive, that is, other devices or portions of the CD drive (such as necessary circuit 204, etc.) might execute data access from the memory chip 21. Therefore, if the central processing unit 201A wants to access data stored in the memory chip 21 while in the meantime other CD drive device is accessing the memory chip 21, the central processing unit 201A could not directly access data from the memory chip 21. As a result, the present invention provides a solution of data access method under the situation described above happen.

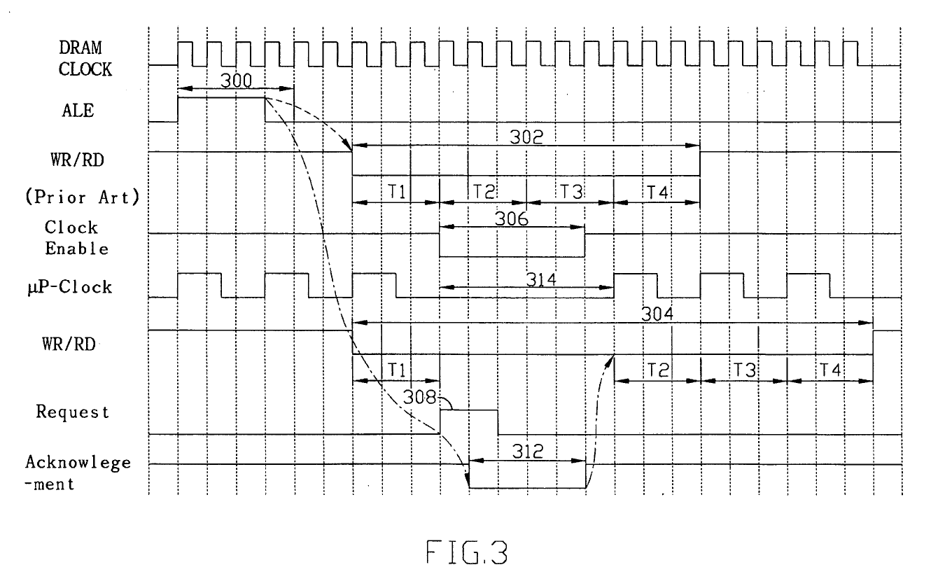

FIG. 3 is a clock timing diagram illustrating the timing operation during the access cycle of the central processing unit 201A from the temporary data segment 210 in FIG. 2B. In a preferred embodiment, the exemplary central processing unit 201A accomplishing with a series of 4 read/write cycle signal 302 in the clock cycle of the processor (μP_CLOCK representing the clock cycle of the processor in FIG. 3) is illustrated in conjunction with the temporary storage 202, when accessing data. When the central processing unit 201A acquires a data address, in case the address latch enable signal 300 (ALE) changes from low level state into high level state, and directs to the temporary storage 202 according to the data address, the data address is transformed at the moment to one corresponding data address of the temporary data segment 210. Next, the central processing unit 201 A begins accomplishing with a series of 4 read/write cycle signal 304 even as it accesses the original temporary storage 202. However, it is possible that the memory chip 21 does not assist the central processing unit 201A to access the temporary data segment 210 for the reason of the temporary is being accessing by other CD drive device (such as necessary circuit 204, etc.). In case of continuously accomplishing the clock signal of processor, an error operation would happen for the central processing unit 201A may access the data with a series of 4 clock circles of processor 302(T1˜T4) (the signal flow shown as a dash line with an arrow).

The present invention resolves the problem mentioned above. In a preferred embodiment, the signal flow is shown as a center line with an arrow in FIG. 3. When acquiring the data address with the address latch enable signal 300 (ALE) and accomplishing the first cycle of read/write cycle signal 304, the control chip 20 sends an access request signal 308 at that moment, and changes the clock enable signal 306 (CLOCK_ENABLE) into low level state. It is noted that at low level state, the clock enable signal 306 would interrupt the clock of processor μP_CLOCK (depicted as the period 314) and, at the same time, suspend data access in the central processing unit 201 A. The clock enable signal returning to high level state may revive data access from the central processing unit 201A. Next, the acknowledgement signal 312(ACK) is changed from high level state into low level state to wait for the memory chip 21 to accomplish the current tasks. Once the memory chip 21 accomplishes the current tasks, the acknowledgement signal 312(ACK) returns to high level state, as well as the clock enable signal 306, permitting the control chip 20 to access data from the temporary data segment 210. Thus, the central processing unit 201A accomplishes data access through a series of cycles of read/write cycles signal 304 (T2, T3, and T4). The clock waveform of the temporary data segment 210 in the present invention can be similar as the cycle of read/write cycles signal 304. It is noted that the central processing unit 201A accomplishes data access with 4 clock cycles of processor for the clock signal of processor (μP_CLOCK) is suspended to wait for the acknowledgement signal 312 from the memory chip 21. Thus, there are no changes for the central processing unit 201A.

However, it is possible that other CD drive device (such as necessary circuit 204, etc.) is accessing the memory chip 21 when the central processing unit 201A would like to accessing data from the temporary data segment 210. Therefore, the control chip 20 must wait for the memory chip 21 to accomplish current tasks prior to continuing accessing data, and the suspended time of the clock signal (the period of acknowledgement signal 312) is dependent on the current tasks accomplished by the memory chip 21. The acknowledgement signal is revived to high level state configured for allowing the control chip 20 to access data from temporary data segment 210. Taking FIG. 3 as an example, the memory chip 21 accomplishes the current tasks with 4 cycles of memory (DRAM_CLOCK) while the central processing unit 201A just wait for 1.33 cycles (because the ratio of DRAM_CLOCK to μP_CLOCK is 3:1, and 4 circles of memory equal to 1.33 times cycles of μP_CLOCK).

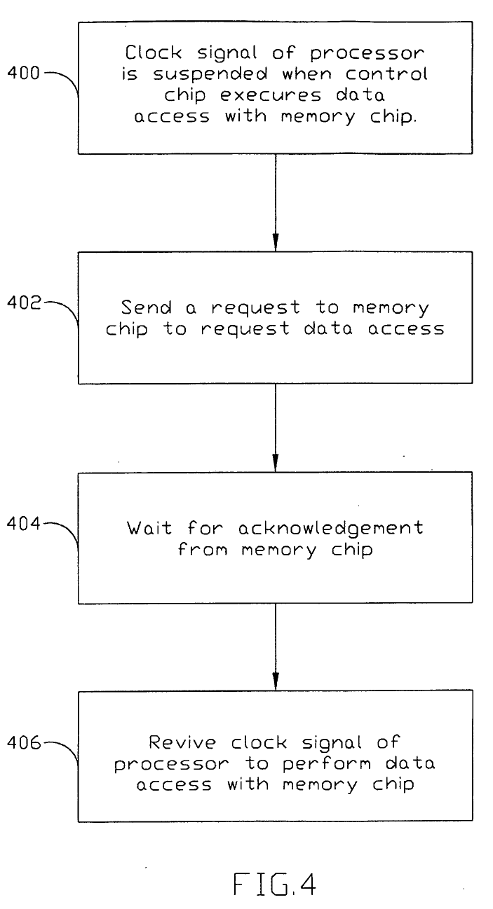

It is noticed that the total operating performance by the central processing unit 201A without reducing dues to the clock circle of the central processing unit 201A is longer than one of the memory chip 21. Moreover, the priority of the central processing unit 201A for accessing data from the memory chip 21 is precedent to others, such as only inferior to the DRAM refresh. Thus, the central processing unit 201A would quickly acquire the necessary data when necessarily accessing the temporary data related to the flow control parameters or the numerical arithmetic. Furthermore, the CD drive in the preferred embodiment of the present invention could be any optical-electronic system, such as a CD-ROM drive, a CD-RW drive, a DVD-ROM drive, a DVD+R drive, a DVD+RW drive, or a DVD-RAM drive. Various modifications and combinations of the illustrative embodiments, as well as other embodiments of the invention, will be apparent to persons skilled in the art upon reference to the description. It is therefore intended that the appended claims encompass any such modifications or embodiments. FIG. 4 is a flowchart diagram illustrating the steps of accessing data for the central processing unit 201A from the temporary data segment 210 of the memory chip 21 in accordance with the present invention. The clock signal of processor in the control chip 20 is suspended when the control chip 20 executing data access from the memory chip 21 (step 400). Then the control chip 20 sends a request signal to the memory chip 21 (step 402) to ask data access from the memory chip 21. Next, the control chip 20 waits for an acknowledgement signal from the memory chip (step 404). After accepting the acknowledgement signal, the control chip 20 revives the clock signal of processor therein so as to perform the data access from the memory chip 21 (step 406).

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. Data access apparatus comprising:
an external memory unit for storing data, wherein the external memory unit has a second time cycles for performing a task; and
a control unit couples with the external memory unit via a memory bus, comprising:
a microprocessor unit, having a first time cycles to perform a microprocessor operating; and
a memory interface control unit for directing accessing data toward to a data address of the external memory unit, wherein the microprocessor unit could access data from the external memory via the memory interface control unit;
wherein the external memory unit has a data segment storing a flow control parameters and numerical arithmetic of the microprocessor operating.

2. The data access apparatus according to claim 1, wherein the first time cycles is much longer than the second time cycles.

3. The data access apparatus according to claim 1, wherein when the microprocessor is going to access data from the data segment of the external memory unit, sending a access request signal and suspending the first time cycles until receiving an acknowledge signal, then reviving the first time cycles immediately.

4. The data access apparatus according to claim 3, wherein duration between suspending and reviving the first time cycles is substantial a time when the second time cycles is finished, that is to say when the external memory unit finishes a current task.

5. The data access apparatus according to claim 1, wherein the external memory unit is a dynamic random access memory (DRAM).

6. The data access apparatus according to claim 1, wherein a capacity of the data segment of the external memory unit is smaller than a capacity of the external memory unit.

7. The data access apparatus according to claim 1, wherein the data access apparatus could be applied to an optical-electronic system and which is selected from: a CD-ROM, CD-RW, DVD+/−ROM, DVD+/−RW.

8. A control unit of data access with couples to an external memory unit, having a second time cycles for performing a task, via a memory bus for an optical-electronic system, the control unit of data access comprising:
a memory interface control unit for directing accessing data toward to a data address of the external memory unit; and
a microprocessor having a first time cycles to perform a microprocessor operation, wherein when the microprocessor is going to access data from the external memory unit via the memory interface, the control unit would send an access request signal to the external memory unit
wherein data of flow control parameters and numerical arithmetic of the microprocessor operating which used to be stored in an internal memory unit of the control unit is replaced by a data segment within the external memory unit.

9. The control unit of data access according to claim 8, wherein the first time cycles is much longer than the second time cycles.

10. The control unit of data access according to claim 8, wherein when sending the access request signal, the first time cycles is suspended in the meantime until receiving a acknowledge signal, then the first tine cycles is revived immediately.

11. The control unit of data access according to claim 10, wherein duration between the first time cycles suspended and revived is substantial a time when the second time cycles is finished, that is to say when the external memory unit finishes a current task.

12. The control unit of data access according to claim 8, wherein the external memory unit is a DRAM.

13. The control unit of data access according to claim 8, wherein a capacity of the data segment of the external memory unit is smaller than a capacity of the external memory unit.

14. The control unit of data access according to claim 8, wherein the optical-electronic is selected from: a CD-ROM, a CD-RW, a DVD+/−ROM, and DVD+/−RW.

15. A data access method comprising:
suspending a first time clock when sending an access request signal; and
reviving the first time clock when receiving an acknowledgement signal;
wherein data selected from: flow control parameters and numerical arithmetic is stored in a data segment of an external memory unit, and the first time cycles is a time for access data stored in the data segment.

16. The data access method according to claim 15, wherein the external memory unit has a second time cycles which is substantial a time for access data stored in the external memory unit.

17. The data access method according to claim 16, wherein cycles of the first time cycles is much longer than cycles of the second time cycles.

18. The data access method according to claim 16, wherein duration of the first time cycles between being suspended and being revived is substantial a time of the second time clock being finished.

19. The data access method according to claim 15, further comprising the external memory unit performs a current task when suspending the first time cycles, and after finishing the current task, reviving the first time cycles immediately.

20. The data access method according to claim 15, wherein the method could be applied to an optical-electronic system which is selected from: a CD-ROM, a CD-RW, a DVD+/−ROM, and a DVD+/−RW.
